(19) United States
(12) Patent Application Publication
(10) Pub. No.: US 2012/0328961 A1
(43) Pub. Date: Dec. 27, 2012

(54) AQEUOUS ELECTROLYTE COMPOSITION AND SEALED-TYPE PRIMARY FILM BATTERY INCLUDING ELECTROLYTE LAYER FORMED OF THE AQUEOUS ELECTROLYTE COMPOSITION

(75) Inventors: Young Gi LEE, Daejeon-city (KR); Kwang Man KIM, Daejeon-city (KR); Kwang Sun RYU, Daejeon-city (KR); Jun Ho YEO, Daejeon-city (KR); Choel Sig PYO, Daejeon-city (KR)

(73) Assignee: ELECTRONICS AND TELECOMMUNICATIONS RESEARCH INSTITUTE, Daejeon-city (KR)

(21) Appl. No.: 13/604,181

(22) Filed: Sep. 5, 2012

Related U.S. Application Data
(62) Division of application No. 11/929,891, filed on Oct. 30, 2007.

(30) Foreign Application Priority Data
Nov. 16, 2006 (KR) 10-2006-0113483
Mar. 13, 2007 (KR) 10-2007-0024688

(51) Int. Cl. H01M 6/04

(52) U.S. Cl. 429/347

(57) ABSTRACT

Provided are an aqueous electrolyte composition including hydrophilic microparticles and a sealed-type primary film battery including an electrolyte layer formed of the aqueous electrolyte composition. In the sealed-type primary film battery, a separation film is interposed between a positive electrode and a negative electrode, and has a plurality of through-holes. A non-flowable electrolyte layer interposed between the positive electrode and the negative electrode includes first and second electrolyte layers extending parallel to the positive electrode and the negative electrode, and a plurality of third electrolyte layers filled in the through-holes of the separation film so as to be integrally connected to the first electrolyte layer and the second electrolyte layer. Due to the third electrolyte layers filled in the through-holes of the separation film, an ion transfer path in the electrolyte layer is shortened. The hydrophilic microparticles are dispersed in the electrolyte layer so as to prevent moisture evaporation.

### CROSS-REFERENCE TO RELATED PATENT APPLICATIONS

This is a divisional of co-pending U.S. application Ser. No. 11/929,891, filed Oct. 30, 2007. This application also claims the benefits of Korean Patent Application No. 10-2006-0113483 filed on Nov. 16, 2006, and No. 10-2007-0024688 filed on Mar. 13, 2007, in the Korean Intellectual Property Office, the disclosures of which are incorporated herein in their entirety by reference.

### BACKGROUND OF THE INVENTION

1. Field of the Invention

The present invention relates to an electrolyte composition and a sealed-type primary film battery. More particularly, the present invention relates to an aqueous electrolyte composition and a sealed-type primary film battery including an electrolyte layer formed of the aqueous electrolyte composition. This work was supported by the IT R&D program of MIC/IITA. [2005-S-106-02, Development of Sensor Tag and Sensor Node Technologies for RFID/USN]

2. Description of the Related Art

Recently, active radio frequency identification (RFID) and sensor node technologies have been actively studied. These technologies, together with digital TVs, home networks, and intelligent robots, have a very significant and extensive effect on a wide range of industries, and thus, are expected to become future important technologies which are superior to the currently available code division multiple access (CDMA) technology. That is, the active RFID and sensor node technologies deviate from a passive function of reading information included in a tag through a reader, and can remarkably increase the recognition distance of tags. Moreover, by sensing information about an object located around a tag and environmental information, the active RFID and sensor node technologies are expected to expand a scope of information flow beyond communication between people and objects to communication between objects by means of networking. Thus, in order to operate such RFID tags and sensor nodes, it is important to secure a power source completely independent from a reader by using a subminiature, lightweight, and long-lasting power device which is suitable for standardized tags or nodes.

To date, attempts have been made to partially apply many power devices to RFID tags and sensor nodes, and the possibility of the application of some power devices in RFID tags and sensor nodes has been acknowledged. Primary film batteries are an example of such a power device. The constructions of electrodes and electrolytes of primary film batteries are the same as those of conventional dry cells and alkaline batteries. However, primary film batteries are not contained in conventional cylindrical cans but are packed with polyethylene terephthalate (PET)-based packages to thereby realize laminated films. Thus, when electrolytes used in conventional cylindrical batteries are applied to film batteries, many problems are caused. In detail, cylindrical batteries are sealed-type batteries, and thus, a separation film is inserted between electrodes and then an aqueous electrolyte solution is sufficiently filled in a space of a battery can. On the other hand, film batteries are obtained by simply laminating electrodes and a separation film, and thus, a contact between each of the electrodes and an electrolyte is weakened, thereby increasing an interfacial resistance. Furthermore, due to a limited space between films, it is difficult to sufficiently impregnate an electrolyte solution into a space between two electrodes. In addition, film batteries are incompletely sealed structures, and thus, when stored for a long time or left at high temperature, an electrolyte solution constituting an electrolyte layer is dried, thereby causing rapid deterioration in battery performance.

In particular, in currently available primary film batteries, it is impossible to sufficiently impregnate an electrolyte solution. Thus, a method of forming an electrolyte layer by impregnating an electrolyte solution into a porous film used as a separation film inserted between two electrodes has been proposed. In primary film batteries manufactured using the above-described method, however, a separation film must be formed to a thickness more than a predetermined value, thereby limiting a reduction in total thickness of the batteries. Furthermore, an ion transfer path in an electrolyte layer is defined along pores that are formed in an irregular shape in a separation film, thus providing a long and irregular ion transfer path. Therefore, an internal resistance is increased and output characteristics are lowered, thereby rapidly lowering battery performance during high-rate continuous discharge or pulse discharge. In addition, when a porous separation film is a film formed of a cellulose or non-woven material and a strongly acidic or basic electrolyte solution is used, the separation film is shrunk or molten due to the electrolyte. Thus, when stored for a long time, batteries may be deteriorated or may not be operated.

### SUMMARY OF THE INVENTION

The present invention provides an aqueous electrolyte composition that can prevent the evaporation of moisture contained in an electrolyte solution and that is compatible with a separation film having resistance to a strongly acidic or basic electrolyte solution.

The present invention also provides a sealed-type primary film battery that exhibits better output characteristics by shortening an ion transfer path in an electrolyte layer and that can be manufactured to a thinner thickness.

According to an aspect of the present invention, there is provided an aqueous electrolyte composition including: a water-soluble polymer; an aqueous electrolyte solution; and hydrophilic microparticles.

The hydrophilic microparticles may be a porous inorganic material or an organic material.

According to another aspect of the present invention, there is provided a sealed-type primary film battery including: a positive electrode; a negative electrode; a separation film interposed between the positive electrode and the negative electrode, the separation film being respectively separated from the positive electrode and the negative electrode by predetermined distances, extending parallel to the positive electrode and the negative electrode, and having a plurality of through-holes; and a non-flowable electrolyte layer filled in a space defined between the positive electrode and the negative electrode. The electrolyte layer includes a first electrolyte layer which is interposed between the positive electrode and the separation film and extends parallel to the positive electrode, a second electrolyte layer which is interposed between the negative electrode and the separation film and extends parallel to the negative electrode, and a plurality of third electrolyte layers which are filled in the through-holes of the separation film so as to be integrally connected to the first electrolyte layer and the second electrolyte layer. The separation film may be formed of a hydrophobic polymer, a woven glass fiber, or a woven carbon fiber.

The electrolyte layer may be formed of a mixture of a water-soluble polymer, an aqueous electrolyte solution, and hydrophilic microparticles.

In a sealed-type primary film battery according to the present invention, hydrophilic microparticles dispersed in an electrolyte layer can prevent evaporation of moisture from an aqueous electrolyte solution. Furthermore, shortened ion transfer paths defined in electrolyte layers filled in through-holes formed in a separation film can provide excellent ion conductivity, thereby improving high-rate discharge characteristics, high output characteristics, and pulse output characteristics. Even when stored or discharged for a long time, deterioration in battery performance is prevented, thereby providing excellent long-term storage stability.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating an essential part of a sealed-type primary film battery according to an exemplary embodiment of the present invention;

FIG. 2 is a partial sectional view taken along a line II-II′ of FIG. 1;

FIG. 3 is a plan view illustrating an example of a separation film of a sealed-type primary film battery according to an exemplary embodiment of the present invention;

FIG. 4 is a plan view illustrating another example of a separation film of a sealed-type primary film battery according to an exemplary embodiment of the present invention;

FIG. 5 is a comparative graph illustrating ionic conductivity of sealed-type primary film batteries manufactured in Examples 1-3 according to the present invention and Comparative Example; and

FIG. 6 is a comparative graph illustrating a change in ionic conductivity of the sealed-type primary film batteries manufactured in Examples 1-3 according to the present invention and Comparative Example, with respect to temperature.

### DETAILED DESCRIPTION OF THE INVENTION

The present invention will now be described more fully with reference to the accompanying drawings, in which exemplary embodiments of the invention are shown.

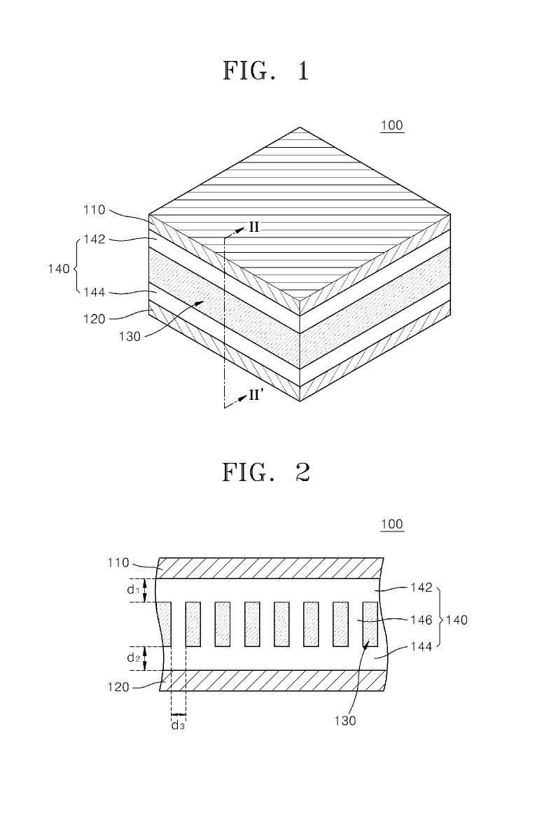

FIG. 1 is a perspective view illustrating an essential part of a sealed-type primary film battery 100 according to an exemplary embodiment of the present invention, and FIG. 2 is a partial sectional view taken along a line II-II′ of FIG. 1.

Referring to FIGS. 1 and 2, the sealed-type primary film battery 100 includes a positive electrode 110, a negative electrode 120, and a separation film 130 interposed between the positive electrode 110 and the negative electrode 120.

The separation film 130 is respectively separated from the positive electrode 110 and the negative electrode 120 by distances d₁ and d₂, and extends parallel to the positive electrode 110 and the negative electrode 120. The separation film 130 may have a thickness of about 5 to 500 μm.

The separation film 130 is formed of a hydrophobic material. The separation film 130 may be formed of a porous or non-porous material.

The separation film 130 may be formed of a hydrophobic polymer. For example, the separation film 130 may be formed of a polymer or a blend of at least two polymers selected from the group consisting of polyethylene, polytetrafluoroethylene, polystyrene, polypropylene, polyvinylchloride, polyvinylidenechloride, polyvinylidenefluoride, a copolymer of vinylidenefluoride and hexafluoropropylene, a copolymer of vinylidenefluoride and trifluoroethylene, a copolymer of vinylidenefluoride and tetrafluoroethylene, nylon, polyacrylonitrile, ethylvinylalcohol, polyethyleneterephthalate (PET), polybutyleneterephthalate (PBT), polysulfone, polyimide, polyurethane, polybutadiene, polymethylacrylate, polyethylacrylate, polymethylmethacrylate, polyethyl methacrylate, polybutylacrylate, and polybutylmethacrylate. The separation film 130 may also be formed of a woven glass fiber or a carbon fiber.

FIG. 3 is a plan view illustrating a separation film 130A which is an example of the separation film 130.

Referring to FIG. 3, the separation film 130A includes a hydrophobic film 134 which is in the form of an extruded film, and a plurality of through-holes 132 are present in the hydrophobic film 134. FIG. 3 illustrates that the through-holes 132 have a circular shape, but the present invention is not limited thereto. That is, the through-holes 132 may have an elliptical shape or a polygonal shape. An opening width W₁ of the through-holes 132 may be as relatively large as about 10 μm to 2 mm.

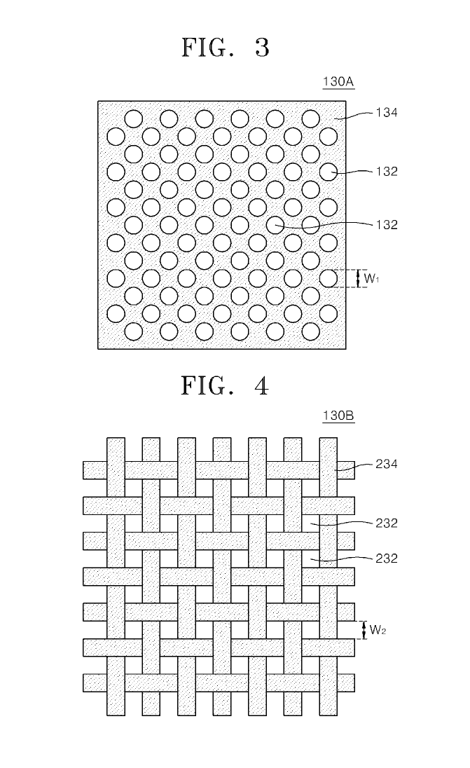

FIG. 4 is a plan view illustrating a separation film 130B which is another example of the separation film 130.

Referring to FIG. 4, the separation film 130B includes a woven film 234, and a plurality of through-holes 232 are present in the woven film 234. The through-holes 232 may have an opening width W₂ of about 10 μm to 2 mm.

Referring again to FIGS. 1 and 2, a non-flowable electrolyte layer 140 is filled in a space between the positive electrode 110 and the negative electrode 120. The non-flowable electrolyte layer 140 includes a first electrolyte layer 142 which is interposed between the positive electrode 110 and the separation film 130 and extends parallel to the positive electrode 110; a second electrolyte layer 144 which is interposed between the negative electrode 120 and the separation film 130 and extends parallel to the negative electrode 120; and a plurality of third electrolyte layers 146 filled in through-holes (132 of FIG. 3 or 232 of FIG. 4) of the separation film 130 so as to be integrally connected to the first electrolyte layer 142 and the second electrolyte layer 144. The third electrolyte layers 146 have a width d₃ which is determined according to the opening width (W₁ of FIG. 3 or W₂ of FIG. 4) of the through-holes of the separation film 130. The third electrolyte layers 146 provide a shortened transfer path of ions present in the non-flowable electrolyte layer 140 between the positive electrode 110 and the negative electrode 120. Therefore, an internal resistance of the sealed-type primary film battery 100 is reduced, thereby enhancing output characteristics.

Each of the first electrolyte layer 142 and the second electrolyte layer 144 may be formed to a thickness of about 10 to 300 μm.

The non-flowable electrolyte layer 140 may be formed of a mixture of a water-soluble polymer, an aqueous electrolyte solution, and hydrophilic microparticles. In the non-flowable electrolyte layer 140, the hydrophilic microparticles are present in a dispersed state in the aqueous electrolyte solution, thus preventing the evaporation of the aqueous electrolyte solution through an interaction of them with the aqueous solution.

The water-soluble polymer included in the non-flowable electrolyte layer 140 may be a polymer or a blend of at least two polymers selected from the group consisting of polyethyleneoxide, polypropyleneoxide, starch, polyacrylic acid, polyvinylalcohol, polyvinylacetate, cellulose, cellulose acetate, carboxymethylcellulose, agar, and Nafion.

The aqueous electrolyte solution included in the non-flowable electrolyte layer 140 may be an aqueous solution including an electrolyte selected from potassium hydroxide (KOH), sodium hydroxide (NaOH), potassium bromide (KBr), potassium chloride (KCl), sodium chloride (NaCl), zinc chloride (ZnCl₂), ammonium chloride (NH₄CI), sulfuric acid (H₂SO₄), and Nafion.

The hydrophilic microparticles included in the non-flowable electrolyte layer 140 may be a porous inorganic material or an organic material. When the hydrophilic microparticles are a porous inorganic material, they may be silica, talc, alumina (Al₂O₃), titania (TiO₂), clay, or zeolite. When the hydrophilic microparticles are an organic material, they may be polyethyleneimine, ethyleneglycol, or polyethyleneglycol.

A method of forming an electrolyte layer of a sealed-type primary film battery according to an exemplary embodiment of the present invention will now be described with reference to FIGS. 1 through 4.

First, an aqueous electrolyte composition according to an embodiment of the present invention is prepared. For this, a water-soluble polymer, an aqueous electrolyte solution, and hydrophilic microparticles are prepared. A separation film 130 having the same structure as a separation film 130A of FIG. 3 or a separation film 130B of FIG. 4 is also prepared. Materials for the water-soluble polymer, the aqueous electrolyte solution, and the hydrophilic microparticles are as described above. For example, the aqueous electrolyte solution may be an electrolyte solution obtained by dissolving any one of the above-exemplified electrolytes in a concentration of about 1-8 M in distilled water. The separation film 130 may be a hydrophobic polymer film having through-holes (see 132 of FIG. 3). Alternatively, the separation film 130 may be a woven glass fiber or carbon black having through-holes (see 232 of FIG. 4). An opening size of the through-holes is relatively large enough to be observed by the naked eye.

The aqueous electrolyte composition is prepared by mixing the water-soluble polymer, the aqueous electrolyte solution, and the hydrophilic microparticles. In detail, the hydrophilic microparticles are first added to the aqueous electrolyte solution to obtain a mixture. Here, the hydrophilic microparticles may be added in an amount of about 0.1 to 50 wt % based on the total weight of the aqueous electrolyte solution. Then, the water-soluble polymer is dissolved in the mixture to prepare a highly viscous polymer electrolyte in the form of a slurry or solution. The polymer electrolyte is coated to a predetermined thickness on both surfaces of the separation film 130 and dried. During the coating, the polymer electrolyte is filled in the through-holes present in the separation film 130, and at the same time, a polymer electrolyte film is uniformly formed on the surfaces of the separation film 130.

When the coated polymer electrolyte is dried, a gel- or paste-type non-flowable electrolyte layer 140 is formed. According to the type of the water-soluble polymer, the electrolyte layer 140 may have a viscous property or may be solidified after evaporation of a solvent so as to form a structure that the electrolyte layer 140 is integrated with the separation film 130. The electrolyte layer 140 includes a first electrolyte layer 142 and a second electrolyte layer 144 covering both the surfaces of the separation film 130, and a plurality of third electrolyte layers 146 which are interposed between the first electrolyte layer 142 and the second electrolyte layer 144 and filled in the through-holes of the separation film 130 so as to be integrally connected to the first electrolyte layer 142 and the second electrolyte layer 144, as illustrated in FIG. 2.

A positive electrode 110 and a negative electrode 120 are respectively formed on both surfaces of the resultant structure including the separation film 130 and the electrolyte layer 140 to obtain a sealed-type primary film battery 100. In a sealed-type primary film battery manufactured using the above-described method according to the present invention, ion transfer is performed along short ion paths defined by third electrolyte layers (see 146 of FIG. 2) filled in through-holes of a separation film, thereby allowing the sealed-type primary film battery to have good output characteristics. Even though the thickness of the separation film is reduced to a half or less of the thickness of a separation film formed in the prior art, desired ionic conductivity can be achieved, thereby enabling manufacture of thinner primary film batteries.

Hereinafter, preparation of an aqueous electrolyte composition and manufacture of a sealed-type primary film battery according to the present invention will be described more specifically with reference to the following examples. The following examples are only for illustrative purposes and are not intended to limit the scope of the invention. Based on the following examples, various changes may be made without departing from the spirit of the present invention.

### Example 1

Porous polyethylene (PE) films having a thickness of 20 μm were prepared. Then, a plurality of circular through-holes having a diameter of 500 μm were formed in the porous PE films using a perforator to prepare separation films.

In order to prepare an aqueous electrolyte composition, 5 wt % of polyethyleneimine which was hydrophilic microparticles was added to a 6 M potassium hydroxide (KOH) solution, and 10 wt % of a polymer blend of polyacrylic acid and carboxymethylcellulose (1:1 by weight) was added thereto to prepare a very waxy electrolyte gel. The electrolyte gel was coated on both surfaces of the separation films to form electrolyte layers. At this time, the electrolyte gel coated on the surfaces of the separation films flowed into and was completely filled in the through-holes formed in the separation films.

Positive electrode films and negative electrode films were laminated and sealingly adhered on both surfaces of the resultant structures including the separation films and the electrolyte layers to manufacture sealed-type primary film batteries. In detail, a polyethyleneterephthalate (PET) film and a conductive carbon were coated and pressed on a surface of an electrolyte layer covering a surface of each separation film, and a slurry prepared by mixing EMD (electrolytic MnO₂), a binder, and a conductive material was coated thereon to form a positive electrode. A slurry prepared by mixing Zn particles, a binder, and a conductive material was coated on a surface of an electrolyte layer covering the other surface of each separation film to form a negative electrode.

### Example 2

Sealed-type primary film batteries were manufactured in the same manner as in Example 1 except that a polymer blend of polyethyleneoxide and polyvinylalcohol (1:1, by weight) was used instead of the polymer blend of polyacrylic acid and carboxymethylcellulose.

### Example 3

Sealed-type primary film batteries were manufactured in the same manner as in Example 1 except that woven glass fibers having a thickness of 100 μm were used as separation films, and a 6 M ammonium chloride (NH₄Cl) solution was used instead of the 6 M KOH solution to prepare an aqueous electrolyte composition.

### Comparative Example

Conventional liner paper/ammonium chloride electrolyte systems applied to manganese batteries and alkaline batteries were prepared according to the prior art. For this, liner papers having a thickness of 120 μm were impregnated with a 6 M ammonium chloride solution. Positive electrodes and negative electrodes were formed on the electrolyte systems in the same manner as in Example 1 to prepare primary film batteries.

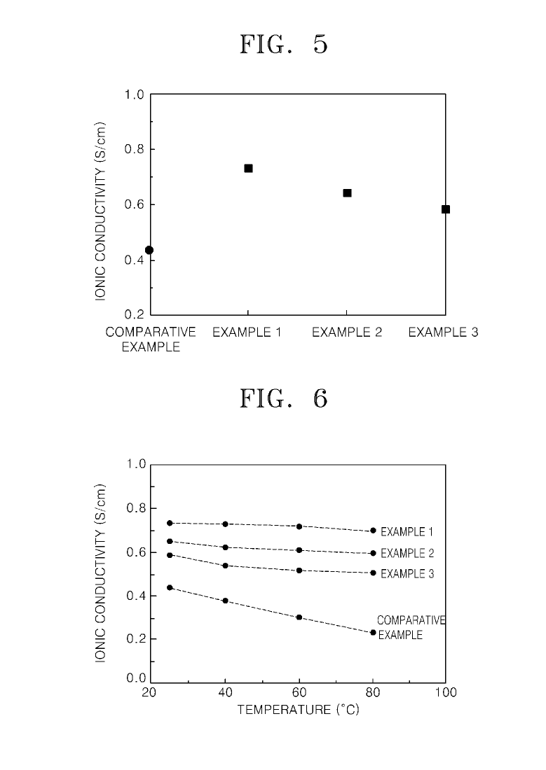

In order to evaluate ionic conductivity characteristics of a sealed-type primary film battery according to the present invention, ionic conductivities of the sealed-type primary film batteries manufactured in Examples 1-3 and Comparative Example were compared, and the results are illustrated in a graph of FIG. 5.

As illustrated in FIG. 5, the primary film batteries of Examples 1-3 exhibited better ionic conductivity than the primary film batteries of Comparative Example. The results of FIG. 5 show that in the primary film batteries of Examples 1-3, an ion transfer path per unit length is shortened compared to the primary film batteries of Comparative Example under the same voltage application conditions, thereby leading to enhanced ionic conductivity, thus achieving good high-rate discharge and high output characteristics.

In order to evaluate a change in ionic conductivity with respect to temperature in a sealed-type primary film battery according to the present invention, ionic conductivities of the sealed-type primary film batteries manufactured in Examples 1-3 and Comparative Example were compared, and the results are illustrated in a graph of FIG. 6.

As illustrated in FIG. 6, when measuring ionic conductivity while raising a temperature to 80° C., the primary film batteries of Examples 1-3 exhibited almost constant ionic conductivity (i.e., little change in ionic conductivity) compared to the primary film batteries of Comparative Example. The results of FIG. 6 show that the primary film batteries of Examples 1-3 underwent a remarkable reduction in deterioration of battery performance that may be caused due to evaporation of an electrolyte solution when stored or left for a long time.

An aqueous electrolyte composition according to the present invention includes hydrophilic microparticles. A porous inorganic material or an organic material forming the hydrophilic microparticles is impregnated with an aqueous electrolyte solution to thereby prevent the evaporation of the aqueous electrolyte solution. The aqueous electrolyte composition including the hydrophilic microparticles is used to form an electrolyte layer, in which the hydrophilic microparticles are dispersed, on both surfaces of a separation film having a plurality of through-holes therein, thereby preventing the evaporation of moisture from the electrolyte layer. Furthermore, a water-soluble polymer included in the aqueous electrolyte composition according to the present invention may have a good adhesion force or may be solidified after solvent evaporation so as to integrate electrodes and the separation film via the electrolyte layer.

A sealed-type primary film battery according to the present invention provides good ionic conductivity through shortened ion transfer paths defined by electrolyte layers filled in through-holes formed in a separation film. Therefore, the sealed-type primary film battery can be improved in high-rate discharge characteristics, high output characteristics, and pulse output characteristics, and even when stored or discharged for a long time, undergoes no deterioration in battery performance, thereby providing good long-term storage stability. In addition, since the through-holes formed in the separation film are used as ion transfer paths, it is possible to form the separation film using a material having good resistance to strong acid or base, and thus, even when the batteries are used for a long time, deformation (e.g. corrosion or shrinkage) of the separation film can be prevented, thereby increasing the lifetime of the batteries. Furthermore, it is possible to form the separation film to be thinner, thereby enabling manufacture of a thinner battery.

A sealed-type primary film battery according to the present invention can be manufactured using facilities applied to conventional battery manufacture processes, thereby reducing production costs and thus enabling automated, continuous, and large-scale production.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An aqueous electrolyte composition comprising:
a water-soluble polymer;
an aqueous electrolyte solution; and
hydrophilic microparticles.

2. The aqueous electrolyte composition of claim 1, wherein the water-soluble polymer is a polymer or a blend of at least two polymers selected from the group consisting of polyethyleneoxide, polypropyleneoxide, starch, polyacrylate, polyvinylalcohol, polyvinylacetate, cellulose, cellulose acetate, carboxymethylcellulose, agar, and Nafion.

3. The aqueous electrolyte composition of claim 1, wherein the aqueous electrolyte solution is a solution obtained by dissolving potassium hydroxide (KOH), sodium hydroxide (NaOH), potassium bromide (KBr), potassium chloride (KCI), sodium chloride (NaCl), zinc chloride (ZnCl₂), ammonium chloride (NH₄CI), sulfuric acid (H₂SO₄), or Nafion in a concentration of 1-8 M in distilled water.

4. The aqueous electrolyte composition of claim 1, wherein the hydrophilic microparticles are a porous inorganic material.

5. The aqueous electrolyte composition of claim 4, wherein the hydrophilic microparticles are silica, talc, alumina (Al₂O₃), titania (TiO₂), clay, or zeolite.

6. The aqueous electrolyte composition of claim 1, wherein the hydrophilic microparticles are an organic material.

7. The aqueous electrolyte composition of claim 6, wherein the hydrophilic microparticles are polyethyleneimine, ethyleneglycol, or polyethyleneglycol.

8. The aqueous electrolyte composition of claim 1, wherein the hydrophilic microparticles are contained in an amount of 0.1 to 50 wt % based on the total weight of the aqueous electrolyte solution.
